(19) United States
(12) Patent Application Publication
(10) Pub. No.: US 2022/0167464 A1
(43) Pub. Date: May 26, 2022

(54) FILM-TYPE HEATER CAPABLE OF THREE-DIMENSIONAL SHAPE DEFORMATION AND METHOD FOR MANUFACTURING THE SAME

(71) Applicant: LATTRON CO.,LTD., Daejeon (KR)

(72) Inventors: Jae Choon LEE, Daejeon (KR); Chung Kook LEE, Daejeon (KR); Young Seong WANG, Daejeon (KR)

(73) Assignee: LATTRON CO.,LTD., Daejeon (KR)

(21) Appl. No.: 17/610,091

(22) PCT Filed: Apr. 7, 2020
(86) PCT No.: PCT/KR2020/004690

§ 371 Date: Jan. 13, 2022

(30) Foreign Application Priority Data
May 10, 2019 (KR) 10-2019-0054998

(51) Int. Cl. H05B 3/34; H05B 3/03; H05B 3/04

(52) U.S. Cl. CPC H05B 3/34; H05B 3/03; H05B 2203/017; H05B 2203/003; H05B 3/04

(57) ABSTRACT

Disclosed are a heater in the form of a film and a method for manufacturing the same. A film-type heater includes an upper film, a lower film, and a heating element having a heating part of a pattern of heating part set between the upper film and the lower film, wherein the films have a shape of a pattern of heating part by removing films other than the pattern of heating part.

### BACKGROUND OF THE INVENTION

### Field of the Invention

The present invention relates to a film-type heater and a method for manufacturing the same, and more particularly, to a film-type heater capable of three-dimensionally deformable shape that can be attached to a base member and provides elasticity and bending in three dimensions, and a manufacturing method thereof.

### Description of the Related Art

Conventionally, a planar heating element including a wire-type heating wire such as nickel or chromium or a heating fabric printed in a pattern set between an upper film and a lower film may be directly attached to clothes.

However, since the conventional wire-type heating wire is thin and thin, the heating area may be small and the possibility of disconnection is very high. In addition, the conventional planar heating element provides a certain degree of elasticity and bending by the physical properties of the film itself, but since it is a planar film, there is a problem of providing limited elasticity and bending.

### DETAILED DESCRIPTION OF THE INVENTION

### Technical Subjects

In order to solve the above problems, the present invention forms a heating element with a pattern of heating part set between the upper film and the lower film, and removes the films located in a portion other than the pattern of heating part, so that the film can be three-dimensionally deformed having the shape of the pattern of heating part. A heater in the form of a film is provided.

### Means of Problem Solving

A film-type heater capable of three-dimensional shape deformation according to the present invention for the above-mentioned problem includes an upper film, a lower film, and a heating element formed between the upper film and the lower film,

wherein the heating element has a flat surface having a width wider than the thickness, and includes a heating part on which a pattern of heating part is formed with a predetermined length and an electrode part formed on both ends of the heating part,
and the upper film and the lower film have the shape of the pattern of heating part by removing parts other than the pattern of heating part, and three-dimensional shape transformation is possible.

The heater according to the present invention can be attached to the base member using an adhesive, and the base member has a detachable means for attaching and detaching the heater to a target object.

According to the present invention, A manufacturing method of film-type heater capable of three-dimensional shape deformation including an upper film, a lower film, and a heating element formed between the upper film and the lower film, a flat surface having a width wider than the thickness is formed on an upper part of the lower film, comprising the steps of; forming the heating element including a heating part having a flat surface having a width wider than the thickness on which a pattern of heating part with a predetermined length and an electrode part formed on both ends of the heating part; forming the upper film on the heating element; and removing films other than the pattern of the heating part using a cutting means or laser means, wherein the upper film and the lower film have a shape of the pattern of heating part, and three-dimensional shape transformation is possible.

### The effect of the Invention

The present invention can increase the heating area by manufacturing a film-type heater capable of three-dimensional shape deformation, can reduce the risk of disconnection, and have higher elasticity and bendability than a planar heating element.

The present invention can adjust the width and length of the heating part, so it can be attached to clothes, mats, thermostats, etc. for keeping warm.

In addition, since the heating element is wrapped using a film, there is a waterproof effect.

### BRIEF DESCRIPTION OF THE DRAWINGS

FIG. 1 is a plan view showing a heater in the form of a film according to an embodiment of the present invention.

FIG. 2 is a cross-sectional view illustrating a portion A of FIG. 1.

FIG. 3 is a view showing a flow of manufacturing a heater in the form of a film according to an embodiment of the present invention.

### DESCRIPTION OF THE PREFERRED EMBODIMENT

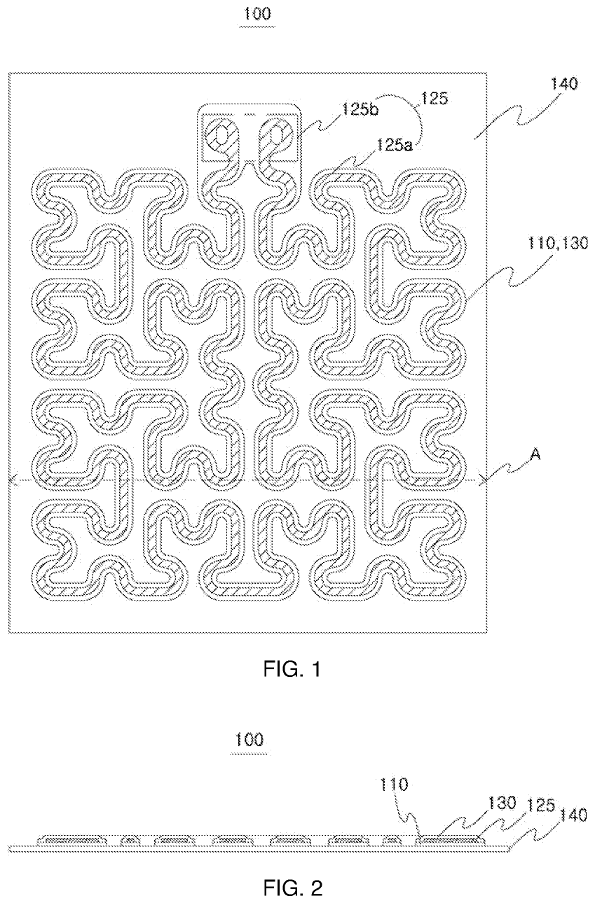

FIG. 1 is a plan view illustrating a film-type heater according to an embodiment of the present invention, and FIG. 2 is a cross-sectional view illustrating part A of FIG. 1. A heater 100 in the form of a film includes a lower film 110, a heating element 125, and an upper film 130. The heating element 125 is formed on the lower film 110, and the upper film 130 is formed on the heating element 125.

The upper film 130 or the lower film 110 may be a thermoplastic resin, polyester (PET), polyimide (PI), polyetherether ketone (PEEK), polyethylene naphthalate (PEN), or polycarbonate (PC). In addition, the upper film 130 or the lower film 110 may be a stretchable and bendable film, but is not limited thereto.

The heating element 125 is in the form of a film. The film is flexible and can undergo three-dimensional shape transformation that involves complex deformations including shape change, elongation, shrinkage, bending or twisting in the horizontal, vertical, or height directions.

The heating element 125 includes a heating part 125a and an electrode part 125b. The heating part 125a is formed with a plane having a wider width than a thickness to reduce a risk of disconnection and increase a heating area, and a pattern of heating part is formed with a predetermined length to increase the heating area and adjust resistance. As shown in FIG. 1, the heating part 125a is zigzag, and the pattern of heating part may be formed in a curved shape, and the pattern of heating part may be formed in the shape of an angular shape at the edge of the plane, and various shapes.

The electrode part 125b is formed on both ends of the heating part 125a to provide a function of supplying current to the heating part 125a.

The upper film 130 and the lower film 110 may have a shape of the pattern of heating part by removing parts other than the pattern of heating part, may be three-dimensionally deformed, and may be wider than an area of the heating element 125 to wrap and waterproof the heating element 125. More specifically, the heater 100 is waterproof by adhering the upper film 130 and the lower film 110 using an adhesive before cutting and removing the peripheral film adjacent to the heating part 125a. It is to provide waterproofing of the heating element 125 by the upper film 130 and the lower film 110 remaining even if the peripheral film is removed.

In the present invention, when an external force is applied to the heater 100, a shape deformation occurs in which the heater 100 is three-dimensionally stretched or bent. In the present invention, three-dimensional shape deformation means deformation such as shape change, elongation, reduction, bending or twisting in the horizontal, vertical or height direction of the heater 100 when an external force is applied to the heater 100. In addition, the three-dimensional shape deformation means a deformation in which the shape change, elongation, shrinkage, bending, or twisting of the heater 100 also occurs in combination. The deformed heater 100 may return to its original shape by elasticity to return to its original state.

A heating film 120 before being formed of a heating element is formed of a heating material such as aluminum, copper, carbon, silver, nickel-chromium alloy, or stainless steel. The electrode part 125b may be connected to a power line by forming a rivet, or may be connected to the power line by soldering. In addition, a part where the electrode part 125b and the power line are connected may be sealed using a material such as epoxy, silicone, or a film.

The heater 100 in the form of a film may be attached to the base member 140 using an adhesive, and the base member 140 may be provided with a detachable means for attaching and detaching it to a target object. The adhesive does not use water or solvent at all, and it may be a hot melt adhesive that uses a thermoplastic resin. The hot melt adhesive is applied and pressed to a target object in a liquid state at a high temperature and then cooled and solidified within a few seconds to exert adhesive force. The base member 140 may be planar fabric that is strong against heat or chemicals, has excellent waterproof performance, can provide high elasticity, and can be deformed in three dimensions.

The detachable means may be a hook-and-loop fastener, a slide fastener, or a button, but is not limited thereto. The target object may be clothing, a cushion, or a warming device, and the heating clothing may be a top, a bottom, or a warming accessory for keeping warm. The warming accessory may be a scarf or a shoe sole, and a warming device may be a hand warmer or a thermos, but is not limited thereto.

The heater 100 of the present invention can be directly attached to the target object, attached to the base member 140 can be attached to the target object. In the present invention, the heater 100 can be detached from the target object through the base member 140, so that if the user feels hot depending on the season or weather, the heater 100 can be separated from the target object. The heater 100 may be attached.

In the present invention, since the thickness of the heating element of the heater 100 is very thin and the heating area is very wide, the heating efficiency can be improved, and the heating element is formed in a densely set pattern of heating part. For example, assuming that the conventional linear heating element and the heating element 125 of the present invention have the same pattern of heating part and volume, the heating element 125 of the present invention has a wider heating area than the conventional linear heating element, so the heating efficiency can be improved. And it may have a durability life of 2-3 times.

Since the present invention has a very large heating area, it can be easily attached by attaching the heater 100 to the base member 140. Conventionally, it is difficult to attach a wire heating element to the film or the base member 140, but the present invention is a method of attaching a planar heating element to the base member 140, thereby reducing the attachment difficulty.

Since the present invention has a very wide heating area and a thin thickness and light weight, elasticity and bending can be maximized, and the risk of disconnection can be reduced compared to the conventional wire heating element. The heating part of the heater 100 of the present invention may have a thickness of 0.2 mm or less, and may be manufactured in various sizes according to use.

In the present invention, there are few restrictions on the shape of the pattern of heating part, the heating element 125 can be custom-made with various pattern of heating parts, it can heat a large area at a low voltage, and the resistance characteristic due to oxidation or deterioration can be improved.

In the present invention, the upper film 130 and the lower film 110 surrounding the heating element 125 have the shape of the heating element 125 to provide more improved elasticity and bending than the conventional planar heating element, and provide an insulation or waterproof function.

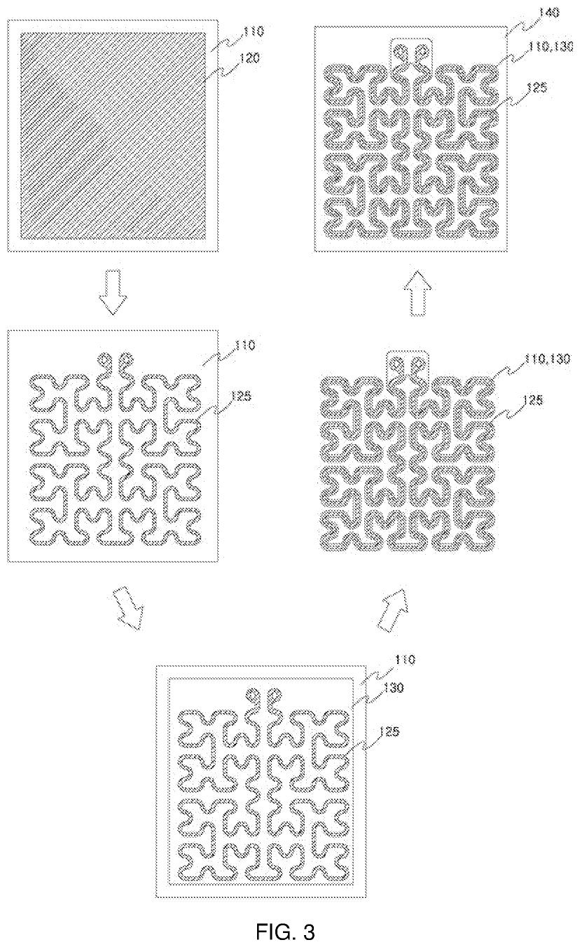

FIG. 3 shows a method flow for manufacturing a heater in the form of a film according to an embodiment of the present invention, in which the heating film 120 is attached to the upper portion of the lower film 110 using an adhesive, and a pattern of heating part is formed using an etching means. The film 120 forms a pattern of heating part having a heating part 125a of a set pattern. Alternatively, a pattern of heating part is printed on the upper portion of the lower film 110 and a heating element having a heating part 125a is formed using a curing means.

The heating element 125 includes a heating part 125a of a set pattern and an electrode part 125b for connection with an electrode.

The pattern of heating part forming method is a method of forming a pattern of heating part by applying a photoresist on the surface of the heating film 120 to develop the pattern of heating part to remain, and removing the part outside the pattern by wet or dry etching, and the surface of the lower film 110 and a method of forming a pattern of heating part on the lower film 110 by printing the pattern of heating part on the substrate.

Next, the upper film 130 is formed on the upper part of the lower film 110 and the heating element 125 by means of a pressing means, and adjacent to the heating part 125a and the electrode part 125b using a cutting means or a laser means. The heater 100 having a pattern of heating part is manufactured by removing the film, and the lower film 110 or the upper film 130 is attached to the base member 140 using an adhesive.

A compression means may include a heating means for applying heat to the upper/lower films and a compression roller for compression, or a thermocompression roller for providing thermocompression bonding together.

The cutting means may include a cutter for cutting the film portion adjacent to the support and the heating part 125a and the electrode part 125b on which the heating film is loaded to have a pattern of heating part.

The laser means may include a support part on which the heating film is loaded, and a laser part that emits laser light to remove the film adjacent to the heating part 125a and the electrode part 125b to have a pattern of heating part.

In the present invention, a printed pattern of heating part may be formed on the lower film 110. In addition, according to the present invention, it is possible to attach the upper or lower films to the base member 140, which is an adherend or a fibrous surface, without distinction of front and back surfaces.

In the present invention, by using the base member 140 having excellent elasticity, it can be detachably attached to the target object, so that the heater 100 is not exposed on the exterior, and the waterproof function of the heater 100 itself and the base member 140. Due to its waterproof function, it is possible to provide waterproofing of a double structure, and it is possible to simultaneously solve the problems of conventional wire-type heating element and planar heating elements.

According to the present invention, by adjusting the width and length of the heating part 125a, it can be attached to various clothes or devices, a target temperature can be easily realized, and the heater 100 can be mass-produced.

### INDUSTRIAL APPLICABILITY

In the present invention, the shape of the heater can be changed in three dimensions by stretching or bending the heater.

The present invention can adjust the width and length of the heating part, so it may be used for keeping warm by attaching it to clothes, mats, and thermostats.

What is claimed is:

1. A film-type heater capable of three-dimensional shape deformation including an upper film, a lower film, and a heating element formed between the upper film and the lower film,
wherein the heating element has a flat surface having a width wider than the thickness, and includes a heating part on which a pattern of heating part is formed with a predetermined length and an electrode part formed on both ends of the heating part,
and the upper film and the lower film have the shape of the pattern of heating part by removing parts other than the pattern of heating part, and three-dimensional shape transformation is possible.

2. The heater according to claim 1, wherein the heater can be attached to the base member using an adhesive, and the base member has a detachable means for attaching and detaching the heater to a target object.

3. A manufacturing method of film-type heater capable of three-dimensional shape deformation including an upper film, a lower film, and a heating element formed between the upper film and the lower film, a flat surface having a width wider than the thickness is formed on an upper part of the lower film, comprising the steps of;
forming the heating element including a heating part having a flat surface having a width wider than the thickness on which a pattern of heating part with a predetermined length and an electrode part formed on both ends of the heating part;
forming the upper film on the heating element; and
removing films other than the pattern of the heating part using a cutting means or laser means,
wherein the upper film and the lower film have a shape of the pattern of heating part, and three-dimensional shape transformation is possible.
